(19) United States
(12) Patent Application Publication
(10) Pub. No.: US 2008/0022541 A1
(43) Pub. Date: Jan. 31, 2008

(54) Proportional ruler

(76) Inventors: Guixian Lu, Pontiac, MI (US); Hengxian Lu, Pontiac, MI (US)

Correspondence Address: Guixian Lu, 853 Melrose St., Pontiac, MI, 48340, US

(21) Appl. No.: 11/493,493

(22) Filed: Jul. 27, 2006

(51) Int. Cl. B43L 7/00

(52) U.S. Cl. 33/494

(57) ABSTRACT

A proportional ruler for dividing a length into equal parts or converting a given length into a proportional length comprises a standard ruler scale and proportional scales with specific proportional coefficients. While a standard ruler scale gives a reading of actual length of an object, proportional scales will give a length equal to the actual length over the proportional coefficient. If a proportional coefficient is a whole number, the scale can be used as a divider to divide a length into the whole number of equal parts.

### BACKGROUND OF THE INVENTION

In order to convert a given length into a result length, people typically measure a given length with a standard ruler. They will then calculate the figure of the result length. Finally they will find a point from the standard ruler with the figure of the result length. This method is time consuming and subject to mistakes.

### SUMMARY OF THE INVENTION

The primary objective of this invention is to shorten the time necessary to convert a given length to a proportional length. The secondary objective is to reduce the possibility of making mistakes.

### BRIEF DESCRIPTION OF THE DRAWING

In the attached drawing, item 1 is a standard ruler scale (the length of item 1 is 12 inches). Item 2 is a one half proportional scale. The length of item 2 is 6 inches). Item 3 denotes the body of the “proportional ruler.” Item 4 is the reference point 10.5, which is the midpoint between point 10 and point 11. Item 4 will be referred in the example below. Item 5 is the reference point 0 which is the beginning point of the one half divider scale. Item 5 will be referred in the example below. A proportional ruler can have many different proportional scales.

### DETAILED DESCRIPTION

A proportional ruler comprises of a wooden, metal or plastic body, a standard ruler scale, and one or more proportional scales. The various scales can be printed or engraved on either side of the body.

The standard ruler scale gives readings of actual length.

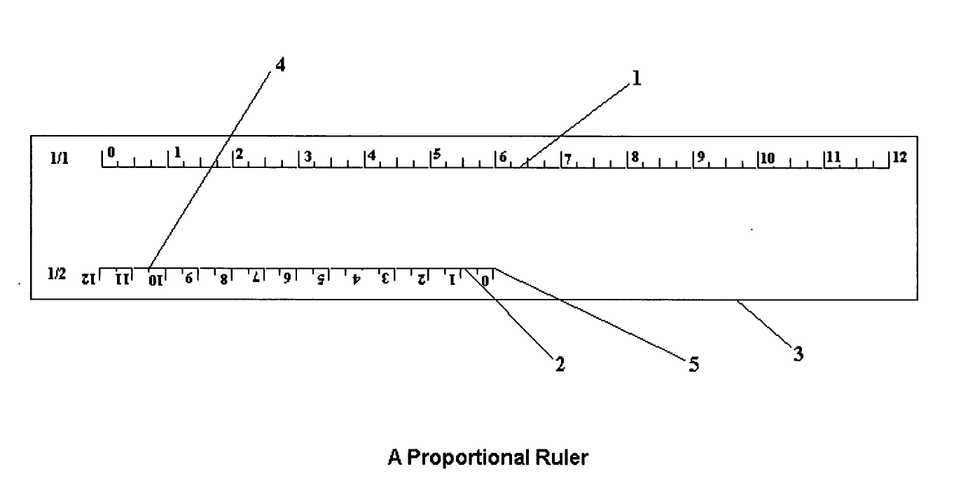

A proportional scale is comprised of a series of numbers and reference points ( graduation ), each of which stands for a scaled length between the reference point 0 and itself. Each point is associated with a figure or reading related with the numbers. The scaled length of each referenced point is equal to the figure or reading associated with the reference point divided by a proportional coefficient of the scale. One proportional scale has one proportional coefficient. If the proportional coefficient is a whole number, the proportional scale will give one of equal parts that the given length will be divided into. Let's use one half proportional scale, the proportional coefficient of which is 0.5, as an example: The reference point 10.5 stands for a scaled length between reference point 0 and reference point 10.5 on the one half scale. The associated figure or reading of this point is 10.5. The scaled length in this example is 5.25 inches, which is equal to the associated figure 10.5 divided by a proportional coefficient 2. The proportional coefficient of the one half scale is whole number 2, therefore the one half scaled can be use to divide a given length into two equal parts. When there is a need to divide a given length into equal parts. The first step is to measure the length with the standard ruler scale to get the reading of actual length. Let's say we want to divide a length of a 10 inches object into halves, thirds, etc. So our standard ruler scale measures 10 inches. Now with the use of the proportional ruler we can easily convert the standard ruler measurement into halves, thirds, etc. The scaled length from point 0 to 10 on a one half (½) proportional scale is 5 inches. The scaled length from point 0 to point 10 in a one third (⅓) proportional scale is 3.333 inches, etc. The entire step of calculating equal parts is eliminated. Thus the proportional ruler shortens the time necessary to divide a given length into equal lengths or parts and reduces the possibility of making mistakes in calculations and in looking for a point associated with different figure.

There are applications of proportional scales with a proportional coefficient that is not equal a whole number.

Measuring the diameter of a circle with a proportional scale with a proportional coefficient of 3.1416 will give a figure of length of the circumference.

When there is a need to divide a circumference into five equal arcs, the first step to draw a five point star, a specific proportional coefficient scale can be use to convert the diameter or radius into the length of the chord for the arc. Then find the five dividing points on the circumference and connect them to form a five points star.

The proportional ruler concept is shown here as applying to a standard ruler scale, however, the divider ruler concept can also be applied to all other known scaled measuring devices, such as, yard sticks and measuring tapes. Also, the proportional ruler scale is not limited to inches and feet but can also be used in measuring devices, which are scaled in metric equivalents, such as, centimeters and meters.

What is claimed is:

1. A proportional ruler that shortens the time for converting a given length into a result length comprising:
a. a standard ruler scale, on which the reading gives actual length of measurement;
b. proportional scales, each of which comprises a series of numbers and reference points ( graduation ), each of which stands for a scaled length from the reference point 0 to itself, which is equal to the figure or reading associated with the reference point over a proportional coefficient;
c. A ruler body where said scales are printed or engraved on;

2. A proportional ruler of claim 1, wherein the length of a said proportional scale is equal to the length of said standard ruler scale over said proportional coefficient.

3. A proportional ruler of claim 1, wherein said proportional scales comprise proportional scales with proportional coefficients of whole numbers.

4. A proportional ruler of claim 1, wherein said proportional scales comprise a proportional scale with proportional coefficient of the ratio of circumference of a circle over the diameter (3.14159) or radius.

5. A proportional ruler of claim 1, wherein said proportional scales comprise a proportional scale with proportional coefficient of the ratio of a diameter of a circle over the arc for the chord or one fifth of the circle.

6. A proportional ruler of claim 1, wherein said proportional scales comprise a proportional scale with proportional coefficient of golden division (0.618).
